(19) United States
(12) Patent Application Publication
(10) Pub. No.: US 2007/0170888 A1
(43) Pub. Date: Jul. 26, 2007

(54) Mobile terminal device

(75) Inventor: Akira Hioki, Kanagawa (JP)

Correspondence Address: YOUNG & THOMPSON, 745 SOUTH 23RD STREET, 2ND FLOOR, ARLINGTON, VA, 22202, US

(73) Assignee: NEC ELECTRONICS CORPORATION, KANAGAWA (JP)

(21) Appl. No.: 11/649,213

(22) Filed: Jan. 4, 2007

(30) Foreign Application Priority Data
Jan. 20, 2006 (JP) 2006-012347

(51) Int. Cl. H02J 7/00

(52) U.S. Cl. 320/107

(57) ABSTRACT

There is provided a mobile terminal device including a verification circuit verifying whether or not an attached external power supply meets a predefined condition, an internal power supply supplying power to the verification circuit, and a power management unit cutting power supply from the external power supply to a terminal body and supplying power from the internal power supply to the verification circuit during verification of the external power supply.

### BACKGROUND OF THE INVENTION

1. Field of the Invention

The present invention relates to mobile terminal devices such as cell phones and PHS, and particularly to a technique of protecting mobile terminal devices from damage caused by the attachment of counterfeit batteries.

2. Description of Related Art

Mobile terminal devices such as cell phones and PHS draw power from a detachable battery pack. A battery mounted on a battery pack is reusable by charging. The battery pack, however, should be replaced when it reaches the end of its life due to degradation of the chemicals within the battery. If the existing battery pack is replaced with a battery pack in the specification and performance which conform to a mobile terminal device, it presents no problem. If, on the other hand, it is replaced with a battery pack which does not conform to a mobile terminal device or a battery pack which is not a qualified product, it can cause defect in a mobile terminal body.

A lithium ion battery which is typically used in battery packs is subject to heating under certain circumstances. If the temperature rising speed of a lithium ion battery is slow, it only leads to the melting of a battery case or the like. However, if the temperature of a lithium ion battery increases rapidly, it can build a pressure to cause a small explosion to occur. Recently, various kinds of counterfeit battery packs are produced increasingly, and accordingly the troubles caused by defects of battery packs occur frequently. To avoid this, a technique of verifying whether or not a battery pack is a qualified product is required.

Examples of such a verification technique are disclosed in Japanese Unexamined Patent Application Publication No. 2005-151368 (Tsuboka et al.), Japanese Patent Translation Publication No. 9-500520 (Rydbeck et al.), and Japanese Unexamined Patent Application Publication No. 10-243089 (Ishida). According to the technique taught by Tsuboka et al., a verification device is included in a mobile terminal body, and a verification receiving device is included in a battery pack. When the mobile terminal body and the battery pack are connected, the verification device in the mobile terminal body transmits a verification signal which combines random numbers and a function decision signal to the verification receiving device in the battery pack. The verification receiving device in the battery pack divides the received verification signal into the random numbers and the function decision signal, generates a random number function using the random numbers and the function decision signal, and transmits it to the mobile terminal body. The verification device in the mobile terminal body compares the received random number function with a pre-calculated random number function, thereby verifying whether or not the battery pack is a qualified product.

According to the technique taught by Rydbeck et al., a specific resistor is mounted on a battery pack. When a mobile terminal body and the battery pack are connected, the mobile terminal body measures the resistance of the resistor mounted on the battery pack to identify whether it shows a specific resistance value, thereby verifying whether or not the battery pack is a qualified product.

According to the technique taught by Ishida, a characteristic value is prestored in a storage circuit which is included in each of a mobile terminal body and a battery pack. When the mobile terminal body and the battery pack are connected, the characteristic value stored in the battery pack is transmitted to the mobile terminal body. The mobile terminal body compares the received characteristic value of the battery pack with the characteristic value stored in the mobile terminal body, thereby verifying whether or not the battery pack is a qualified product.

The above disclosed techniques, however, require power supply from the battery pack to the mobile terminal body upon verification of the battery pack. In the technique of Tsuboka et al., it is necessary to supply power from the outside of the mobile terminal body when verifying the battery pack. This thus requires the external power supply using an AC adopter or the like or the power supply from the battery pack. The technique of Rydbeck et al. uses the power supply from the battery pack when verifying the battery pack. In the technique of Ishida, when verifying the battery pack, the power supply of a backup battery which is included in a mobile terminal body is provided to a verification circuit in the mobile terminal body, and the power supply of the battery pack is provided to a verification circuit in the battery pack through a stabilizer. However, upon transmission of a verification signal from the battery pack to the mobile terminal body, the power of the battery pack can be supplied to the verification circuit in the mobile terminal body. The power supply of the battery pack may possibly provide the power which does not meet the specification, and the use of such power supply for verification causes damage of the mobile terminal body, occurrence of troubles, or the like.

Further, in the above disclosed techniques, the power used for verification is possibly not cut off after completing the verification. In the technique of Tsuboka et al., the power supplied to the verification circuit is not cut off after the verification, so that unnecessary power is kept supplied to the verification circuit. In the techniques of Rydbeck et al. and Ishida, although the power supplied to the verification circuit is cut off after the verification if the battery pack does not meet the specification, the power is not cut off if the battery pack meets the specification. Because the mobile terminal body uses the power for the memory storage or other functions in a storage cell or the like, the unnecessary power supply to a circuit leads to excessive power consumption to cause the degradation in the performance of the mobile terminal a whole.

Furthermore, the battery pack verification methods taught by Rydbeck et al. and Ishida have simple configurations and thus easy to analyze. According to Rydbeck et al., the configuration of an identification circuit which includes the resistor mounted on a qualified battery pack is simple, and therefore it is possible to produce a battery pack which is equivalent to a qualified product easily by configuring a circuit with a resistor having the same value as the resistor. According to Ishida, the characteristic value stored in a qualified battery pack is easy to analyze, and therefore it is also possible to produce a battery pack which is equivalent to a qualified product easily by restoring the circuit in a qualified battery pack. Such easy manufacturing of a counterfeit battery pack not only affects the sales of qualified battery packs but also damages a mobile terminal body due to the connection with a counterfeit battery pack.

### SUMMARY OF THE INVENTION

According to one aspect of the present invention, there is provided a mobile terminal device including a verification circuit verifying whether or not an attached external power supply meets a predefined condition, an internal power supply supplying power to the verification circuit, and a power management unit cutting power supply from the external power supply to a terminal body and supplying power from the internal power supply to the verification circuit during verification of the external power supply.

The non-use of the external power supply during the verification process enables the protection of the mobile terminal body, and the supply of power only during the verification period enables the reduction in power drain of the internal battery used for the verification.

The above configuration enables the provision of a mobile terminal device capable of protecting the mobile terminal body from damage caused by the attachment of counterfeit batteries.

### BRIEF DESCRIPTION OF THE DRAWINGS

The above and other objects, advantages and features of the present invention will be more apparent from the following description taken in conjunction with the accompanying drawings, in which:

FIG. 1 is a view showing the configuration of a mobile terminal device according to a first embodiment of the present invention;

FIG. 2 is a flowchart showing the operation of the mobile terminal device according to the first embodiment of the present invention; and

FIG. 3 is a view showing the configuration of a mobile terminal device according to a second embodiment of the present invention.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

Exemplary embodiments of the present invention are described hereinbelow. The explanation provided hereinbelow and the accompanying drawings are appropriately shortened and simplified to clarify the explanation. Further, the redundant description is omitted as needed to clarify the explanation.

A first embodiment of the present invention is described hereinafter with reference to the drawings. In this embodiment, a mobile terminal device according to the present invention is described as a cell phone terminal by way of illustration, regarding the verification operation when a battery pack is attached to a cell phone terminal and the protection function for the cell phone terminal body during the verification process.

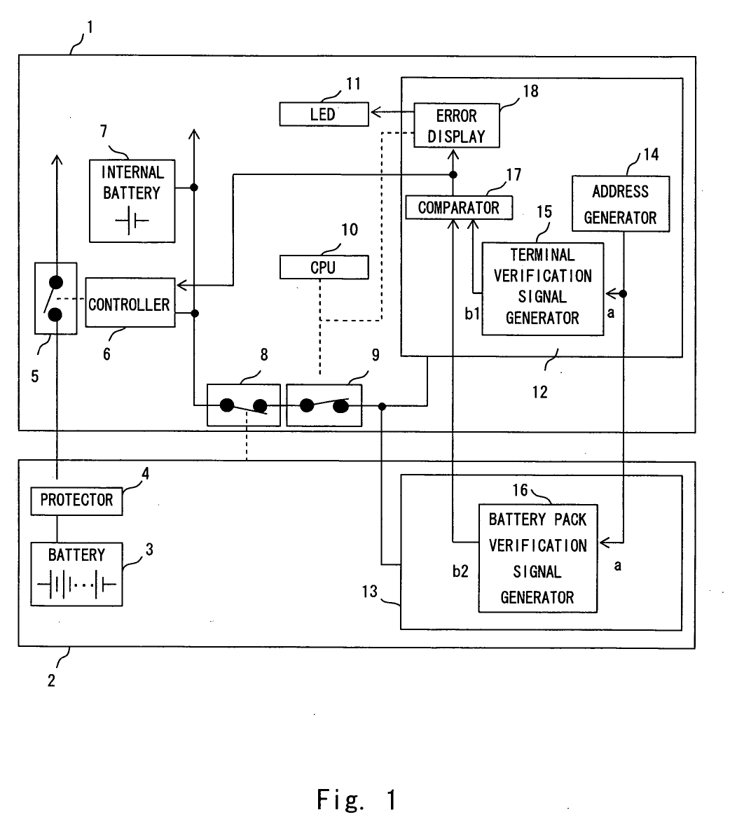

FIG. 1 shows the configuration of a cell phone terminal according to the first embodiment of the invention. The cell phone terminal is composed of a terminal body 1 and a battery pack 2 which is attached to the terminal body 1. FIG. 1 illustrates the configuration regarding the protection function of the cell phone terminal.

The terminal body 1 includes an internal battery 7, an attachment detection switch 8, a power supply switch 9, a LED 11, an address generator 14, a terminal verification signal generator 15, a comparator 17, an error display 18, a power supply switch 5, and a controller 6. The terminal body 1 is provided with a modem device (not shown) centered around a CPU 10 and other functions as a cell phone terminal such as a sound device, a key input unit, a display such as a liquid crystal display or LED, though not particularly shown. The battery pack 2 includes a battery 3, a protector 4, and a battery pack verification signal generator 16. The battery pack 2 is detachable from the terminal body 1.

The terminal body 1 includes a terminal verification circuit 12. The terminal verification circuit 12 includes the address generator 14, the terminal verification signal generator 15, the comparator 17, and the error display 18. Similarly, the battery pack 2 includes a battery pack verification circuit 13 which is composed of the battery pack verification signal generator 16. The terminal verification circuit 12 and the battery pack verification circuit 13 determine whether or not the battery pack 2 is a qualified product when the battery pack 2 is attached to the terminal body 1 and, if not, prohibit the connection between the terminal body 1 and the battery pack 2.

When the terminal body 1 and the battery pack 2 are connected, a power line for supplying power to the terminal verification circuit 12 in the terminal body 1 is connected. At the same time, a power line for supplying power to the battery pack verification circuit 13 in the battery pack 2 and a signal line for verification are connected respectively.

The address generator 14 generates an address “a” for allowing a verification signal to be generated. The address “a” is a signal that indicates the portion where a verification signal is stored. The terminal verification signal generator 15 generates in the terminal body 1 a verification signal “b1” which corresponds to the output address “a”. The battery pack verification signal generator 16 generates in the battery pack 2 a verification signal “b2” which corresponds to the address “a” transmitted from the terminal body 1. The comparator 17 compares the verification signal “b1” supplied from the terminal verification signal generator 15 and the verification signal “b2” transmitted from the battery pack 2.

The LED 11 serves as an annunciator that, if the comparison result in the comparator 17 shows that the verification signals “b1” and “b2” do not match, lights up to notify a user that the battery pack is not a qualified product. Besides the LED lighting up, it is possible to alert a user by the LED flashing or the warning sound such as beeps. However, the warning sound such as beeps requires large current consumption, and the LED flashing requires an internal circuit for flashing to cause large current consumption, which causes excessive power consumption of the internal battery. Thus, the LED lighting up is preferred most among them.

The attachment detection switch 8 turns on/off due to the attachment of the battery pack 2. The connection may be either a mechanical switch or an electrical switch. The power supply switch 9 controls the on/off of the terminal verification circuit 12 and the battery pack verification circuit 13.

If the comparison result in the comparator 17 shows that the verification signals “b1” and “b2” match, the error display 18 outputs a power-off signal to the power supply switch 9 and outputs a signal for enabling the use as a cell phone terminal to the CPU 10. If, on the other hand, the comparison result shows that the verification signals “b1” and “b2” do not match, the error display 18 outputs an error signal to the LED 11 and outputs a power-off signal to the power supply switch 9. It is also possible to output a signal for disabling the use as a cell phone terminal to the CPU 10.

The internal battery 7 is a power supply which is included in the terminal body 1. When the terminal body 1 and the battery pack 2 are connected, it provides power supply to the terminal verification circuit 12 and the battery pack verification circuit 13. Between the terminal verification circuit 12 and the internal battery 7 and between the battery pack verification circuit 13 and the internal battery 7 are provided the attachment detection switch 8 and the power supply switch 9 for controlling on/off of the terminal verification circuit 12 and the battery pack verification circuit 13, and the CPU 10.

The attachment detection switch 8, the power supply switch 9 and the CPU 10 function as a power management unit. The power management unit detects the connection with the battery pack 2 and controls the power supply to the terminal verification circuit 12 and the battery pack verification circuit 13. The power management unit is not limited to be composed of the attachment detection switch 8, the power supply switch 9 and the CPU 10, and may have other configuration. For example, the power management unit may be composed of the power supply switch 9 and the CPU 10.

Although the battery 3 is typically made of chemicals such as lithium, any material may be used as long as it is a rechargeable power supply. The protector 4 is a circuit for protecting the terminal body 1 from overcharge, over discharge and overcurrent of the battery 3. The power supply switch 5 controls the power supply from the battery pack 2 to the terminal body 1.

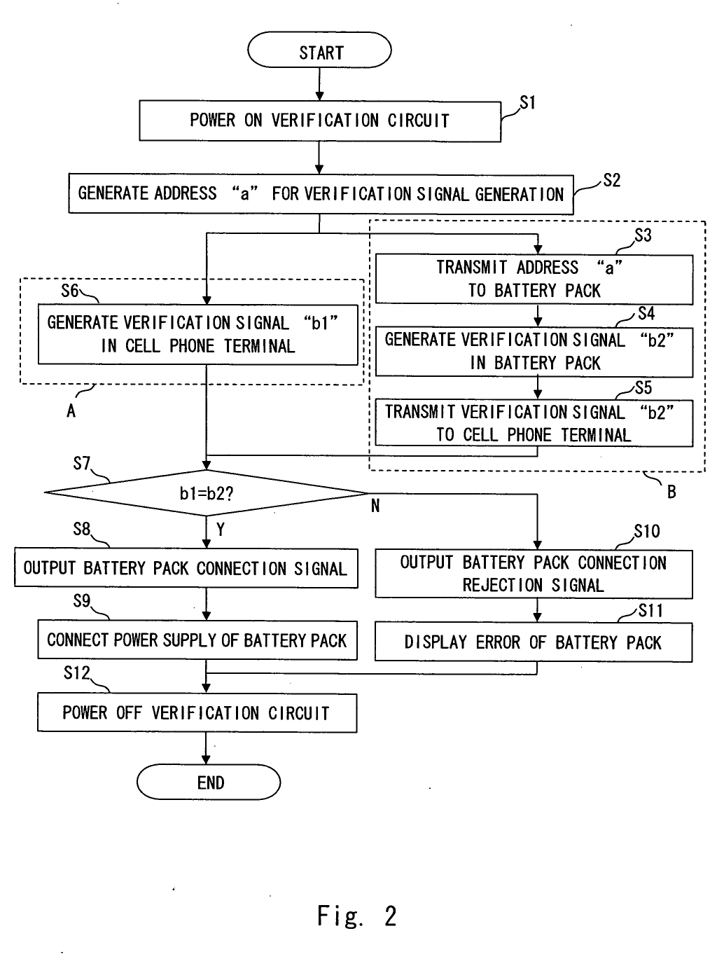

Referring next to FIG. 2, the verification operation of the cell phone terminal according to the first embodiment of the invention is described hereinbelow. FIG. 2 shows a verification flow of a cell phone terminal according to the first embodiment. It illustrates the process from the start to end of the verification of the battery pack 2 when the battery pack 2 is attached to the terminal body 1, including the power supply to the terminal verification circuit 12 and the battery pack verification circuit 13.

A user of the terminal body 1 attaches the battery pack 2 to the terminal body 1 when replacing the existing battery pack 2 which has become exhausted. The attachment causes the attachment detection switch 8 to turn on. Then, the internal battery 7 supplies power to the terminal verification circuit 12 and the battery pack verification circuit 13. As a result, the terminal verification circuit 12 and the battery pack verification circuit 13 are powered on to start the verification of the battery pack 2 (S1).

Firstly, the address generator 14 in the terminal verification circuit 12 generates an address “a” (S2). The address “a” is one of a plurality of addresses which is selectively output. Although the suitable number of addresses is 1 to 5, for example, more addresses may exist. During verification, a different address “a” may be output each time. Alternatively, the same address “a” may be output each time.

The address “a” is then transmitted to the battery pack verification signal generator 16 in the battery pack 2 (S3). At the same time, the address “a” is supplied to the terminal verification signal generator 15. In FIG. 2, the dotted-line portion A indicates the process performed in the terminal body 1, and the dotted-line portion B indicates the process performed in the battery pack 2.

Then, the battery pack verification signal generator 16 generates a verification signal “b2” which corresponds to the address “a” (S4). Similarly, the terminal verification signal generator 15 generates a verification signal “b1” which corresponds to the address “a” (S6).

The verification signal “b2” generated in the battery pack verification signal generator 16 is input to the comparator 17 which is included in the terminal verification circuit 12 (S5). At the same time, the verification signal “b1” generated in the terminal verification signal generator 15 is also input to the comparator 17.

The comparator 17 compares the verification signal “b1” generated in the terminal verification signal generator 15 and the verification signal “b2” generated in the battery pack verification signal generator 16 (S7).

If the verification signals match, the battery pack 2 which is attached to the terminal body 1 is determined as a qualified battery pack. In such a case, the comparator 17 supplies to the controller 6 a signal for enabling the connection with a power line from the battery pack 2 (S8).

In response to the signal for enabling the connection with the battery pack 2, the controller 6 turns on the power supply switch 5. Consequently, the power lines of the battery pack 2 and the terminal body 1 are connected to each other (S9).

Further, the error display 18 supplies a power-off signal to the power supply switch 9. In response to the power-off signal, the power supply switch 9 turns off. The power supply to the terminal verification circuit 12 and the battery pack verification circuit 13 thereby stops (S12). Consequently, the verification of the battery pack 2 ends, and the error display 18 supplies to the CPU 10 a signal for enabling the use as a cell phone terminal. A series of verification process when the verification signals match thereby completes.

On the other hand, if the verification signals do not match, the battery pack 2 which is attached to the terminal body 1 is determined as an unauthorized battery pack. In such a case, the comparator 17 supplies to the controller 6 a signal for rejecting the connection with a power line from the battery pack 2 (S10).

In response to the connection rejection signal from the comparator 17, the error display 18 lights up the LED 11 (S11). The user can thereby recognize that the battery pack is defective.

Further, the error display 18 supplies a power-off signal to the power supply switch 9. In response to the power-off signal, the power supply switch 9 turns off. The power supply to the terminal verification circuit 12 and the battery pack verification circuit 13 thereby stops (S12). Consequently, the verification of the battery pack 2 ends. A series of verification process when the verification signals do not match thereby completes.

### Second Embodiment

A second embodiment of the present invention is described hereinafter with reference to the drawings. In this embodiment, a mobile terminal device according to the present invention is described as a cell phone terminal by way of illustration, regarding the verification operation when a battery pack is attached to a cell phone terminal and the protection function for the cell phone terminal body during the verification process, which is the same as in the first embodiment.

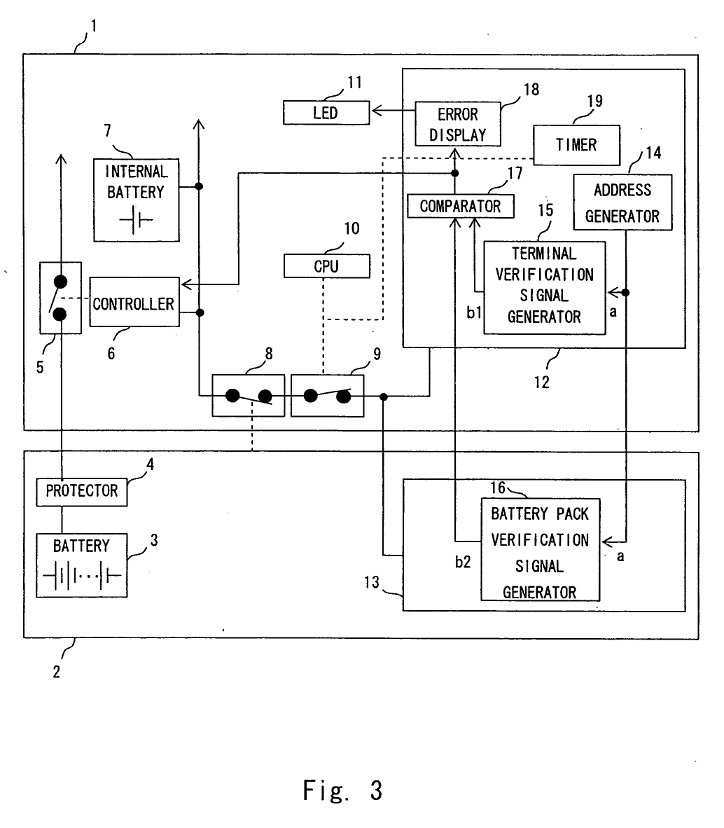

FIG. 3 shows the configuration of a cell phone terminal according to the second embodiment of the invention. The same components, operating principle, etc. of the cell phone terminal as in the first embodiment are not described herein.

In the configuration of FIG. 3, the terminal verification circuit 12 includes a timer 19. This configuration provides the control of the CPU 10 and the on/off of the terminal verification circuit 12 and the battery pack verification circuit 13 by using the timer 19, not a signal from the error display 18.

Specifically, a timer that operates for a verification process period is disposed in the terminal verification circuit 12, so that the timer controls on/off of the power supply switch 9. The other configuration and operation are the same as those in FIG. 1. The verification process period may be set to a pre-measured time period or the like.

In the configuration of the embodiments described above, power is supplied from the internal battery 7 when verifying the battery pack 2. Thus, only the regular power which is provided in the terminal body 1 is connected to the terminal verification circuit 12 and the battery pack verification circuit 13. This prevents the nonstandard power from flowing to the terminal body 1 to damage the terminal body 1 upon verification of the unqualified battery pack 2, for example. This enables the protection of the terminal body 1 from the adverse effect of the nonstandard battery pack 2.

Further, the verification method of the above-described embodiments generates verification signals in the terminal body 1 and the battery pack 2 using the address signal generated in the terminal body 1 and compares those signals each other. Because of such a complicated verification method, a counterfeit battery pack is difficult to produce, thereby protecting the terminal body 1 from the adverse effect of the nonstandard battery pack 2. In addition, the qualified battery pack mounts the verification circuit as LSI, which makes the production of counterfeit products even more difficult.

Further, in the configuration of the embodiments described above, the verification circuit is connected upon attachment of the battery pack 2, and the verification circuit is disconnected from the internal battery 7 upon completion of the verification, regardless of the result. Accordingly, the internal battery 7 can provide minimum power supply, which reduces the battery drain. In mobile terminal devices such as cell phone terminals, the current consumption of each circuit is an important factor which affects the operating time of the device. Therefore, the feature of cutting the unnecessary power supply to a circuit has a significant effect on improving the performance of cell phone terminals.

In the second embodiment, a timer is used to manage the power-off of the verification circuit. The timer is a basic circuit that can be implemented simply with a flip-flop circuit or a logic circuit such as AND or OR. This provides the effects of a simple circuit configuration and lower current consumption.

Further, when the battery pack 2 is determined as an unauthorized battery, the LED light is displayed so as to allow a user to recognize the result clearly. This avoids that a user wrongly recognizes it as an error of the terminal body 1 and pays a cost for unnecessary repair or the like. In addition, this prevents the damage to the corporate image due to the misunderstanding on the product reliability.

The present invention is particularly suitable for the application to mobile terminal devices such as cell phones and mobile information terminals. However the present invention may be applied to any mobile terminal devices as long as they use the attached battery pack or the like as a power supply.

It is apparent that the present invention is not limited to the above embodiment and it may be modified and changed without departing from the scope and spirit of the invention.

What is claimed is:

1. A mobile terminal device comprising:
a verification circuit verifying whether or not an attached external power supply meets a predefined condition;
an internal power supply supplying power to the verification circuit; and
a power management unit cutting power supply from the external power supply to a terminal body and supplying power from the internal power supply to the verification circuit during verification of the external power supply.

2. The mobile terminal device according to claim 1, wherein
the external power supply includes a verification receiving circuit, and
the verification receiving circuit is supplied with power from the internal power supply.

3. The mobile terminal device according to claim 2, wherein the verification circuit comprises:
a comparator comparing a verification receiving signal generated in the verification receiving circuit according to an address signal generated in the verification circuit and a verification signal generated in the verification circuit according to the address signal.

4. The mobile terminal device according to claim 1, wherein the power management unit initiates power supply to the verification circuit upon attachment of the external power supply.

5. The mobile terminal device according to claim 2, wherein the power management unit initiates power supply to the verification circuit upon attachment of the external power supply.

6. The mobile terminal device according to claim 3, wherein the power management unit initiates power supply to the verification circuit upon attachment of the external power supply.

7. The mobile terminal device according to claim 1, wherein the power management unit stops power supply to the verification circuit after completing verification of the external power supply.

8. The mobile terminal device according to claim 2, wherein the power management unit stops power supply to the verification circuit after completing verification of the external power supply.

9. The mobile terminal device according to claim 3, wherein the power management unit stops power supply to the verification circuit after completing verification of the external power supply.

10. The mobile terminal device according to claim 1, further comprising:
a timer controlling a power supply period to the verification circuit.

11. The mobile terminal device according to claim 2, further comprising:
a timer controlling a power supply period to the verification circuit.

12. The mobile terminal device according to claim 3, further comprising:
a timer controlling a power supply period to the verification circuit.

13. The mobile terminal device according to claim 1, further comprising:
a light emitting diode (LED) lighting up when the external power supply is determined to be unauthorized.

14. The mobile terminal device according to claim 2, further comprising:
a light emitting diode (LED) lighting up when the external power supply is determined to be unauthorized.

15. The mobile terminal device according to claim 3, further comprising:
a light emitting diode (LED) lighting up when the external power supply is determined to be unauthorized.
